(19) United States
(12) Patent Application Publication
(10) Pub. No.: US 2025/0242664 A1
(43) Pub. Date: Jul. 31, 2025

(54) RADIANT HEATER

(71) Applicant: Panasonic Automotive Systems Co., Ltd., Kanagawa (JP)

(72) Inventors: Takuya NAKAGAWA, Shiga (JP); Yoshikazu HAYASHI, Shiga (JP); Shota YAMAMOTO, Shiga (JP)

(21) Appl. No.: 19/040,658

(22) Filed: Jan. 29, 2025

(30) Foreign Application Priority Data
Jan. 31, 2024 (JP) 2024-013329

(51) Int. Cl. B60H 1/22

(52) U.S. Cl. CPC B60H 1/2226

(57) ABSTRACT

A radiant heater to be installed in a cabin of a vehicle is provided. The radiant heater includes: a heater element in a flat plate shape; a first outermost layer (radiant sheet) provided on a first surface side of the heater element, the first surface side being a side facing the cabin; and a second outermost layer (heat insulation layer) provided on a second surface side of the heater element, the second surface side being opposite to the first surface side. A thermal resistance of the second outermost layer (heat insulation layer) is greater than a thermal resistance of the first outermost layer (radiant sheet).

### CROSS REFERENCE TO RELATED APPLICATION

The present application is based on and claims priority of Japanese Patent Application No. 2024-013329 filed on Jan. 31, 2024.

### FIELD

The present disclosure relates to a radiant heater.

### BACKGROUND

Patent Literature (PTL) 1 discloses a thermal radiation heater including: a heater element layer including a planar conductive body; a front surface side layer provided close to a front surface of the heater element layer; and a back surface side layer provided close to a back surface of the heater element layer. An outermost layer close to the front surface has an emissivity of 0.7 or more, and an outermost layer close to the back surface has an emissivity of 0.6 or less.

### CITATION LIST

### Patent Literature

PTL 1: WO 2021/002331

### SUMMARY

However, the thermal radiation heater according to PTL 1 can be improved upon.

In view of this, the present disclosure provides a radiant heater capable of improving upon the above related art.

An aspect of the present disclosure provides a radiant heater to be installed in a cabin of a vehicle. The radiant heater includes: a heater element in a flat plate shape; a first outermost layer provided on a first surface side of the heater element, the first surface side being a side facing the cabin; and a second outermost layer provided on a second surface side of the heater element, the second surface side being opposite to the first surface side. A thermal resistance of the second outermost layer is greater than a thermal resistance of the first outermost layer.

A radiant heater according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating an example of the use of a radiant heater according to an embodiment.

FIG. 2 is a cross-sectional view illustrating an internal structure of the radiant heater according to the embodiment.

FIG. 3 is a perspective view illustrating a cover member according to the embodiment.

FIG. 4 is a cross-sectional view illustrating an internal structure of a radiant heater in which a reflective member is formed on a cover member.

FIG. 5 is a cross-sectional view illustrating an internal structure of another radiant heater in which a reflective member is formed on a casing.

FIG. 6 is a cross-sectional view illustrating an internal structure of yet another radiant heater in which reflective members are formed on a cover member.

FIG. 7 is a cross-sectional view illustrating an internal structure of a radiant heater in which a heat insulation layer is an air layer.

FIG. 8 is a cross-sectional view illustrating an internal structure of a radiant heater in which a radiant member is formed on a cover member.

FIG. 9 is a cross-sectional view illustrating an internal structure of yet another radiant heater in which a reflective member is formed on a cover member.

FIG. 10 is a cross-sectional view illustrating an internal structure of yet another radiant heater in which a reflective member is formed on a casing.

### DESCRIPTION OF EMBODIMENT

The exemplary embodiment described below shows a general or specific example. The numerical values, shapes, elements, the arrangement and connection of the elements, etc. shown in the following exemplary embodiment are mere examples, and therefore do not limit the scope of the appended Claims and their equivalents. Among the elements in the following exemplary embodiment, those not recited in the independent claim are described as optional elements.

Each of the figures is a schematic diagram and is not necessarily drawn in a precise manner. Thus, the scale, etc. do not necessarily remain the same throughout the figures. In the figures, substantially the same elements are denoted by the same reference numerals, and duplicated explanations are omitted or simplified.

In the following embodiment, expressions such as a “plate shape” are used. For example, the “plate shape” means not only completely being in the shape of a plate, but also substantially being in the shape of a plate, i.e., including an error of approximately a few percent, for example. The “plate shape” means a plate shape to the extent that the effect according to the present disclosure can be achieved. The same applies to other expressions using the phrase “. . . shape”.

The embodiment will be specifically described below with reference to the drawings.

### Embodiment

### Configuration

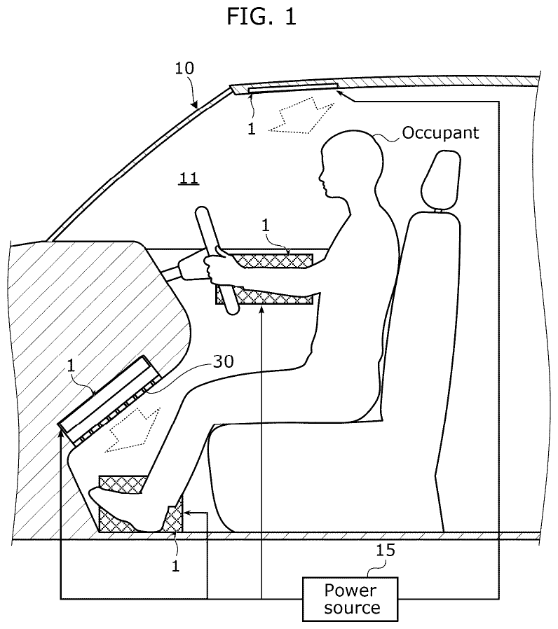

With reference to FIGS. 1 to 3, radiant heater 1 according to the present embodiment will be described first.

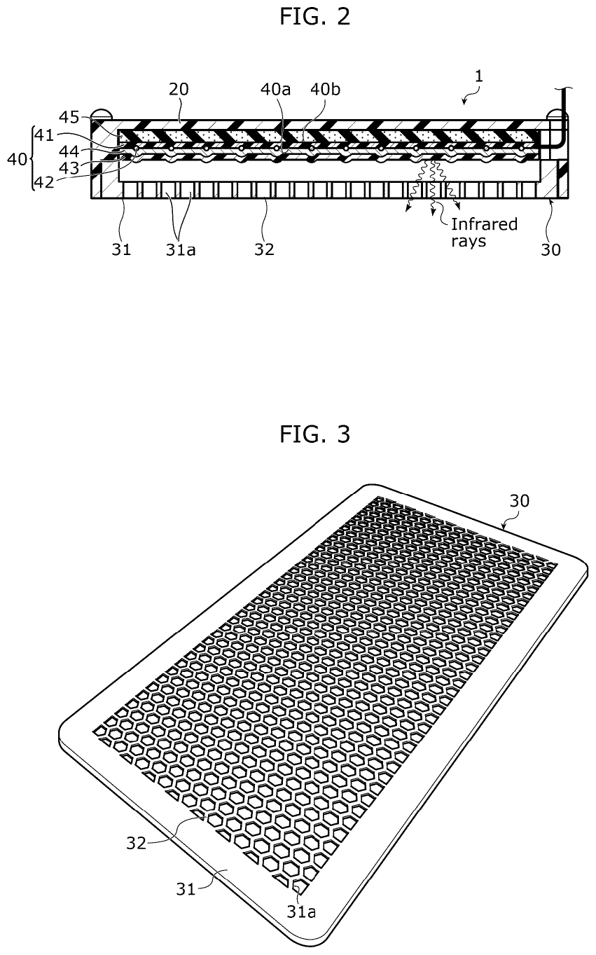

FIG. 1 is a diagram illustrating an example of the use of radiant heater 1 according to the embodiment. FIG. 2 is a cross-sectional view illustrating an internal structure of radiant heater 1 according to the embodiment. FIG. 3 is a perspective view illustrating cover member 30 according to the embodiment.

As shown in FIG. 1, radiant heater 1 is installed in cabin 11 of vehicle 10 that travels on a road. Radiant heater 1 constitutes a part of a heating system for the cabin. Radiant heater 1 is a heater configured to generate heat when powered by power source 15 installed in vehicle 10. Radiant heater 1 can emit the generated heat into cabin 11. Radiant heater 1 according to the present embodiment is of a flat plate shape. In this case, radiant heater 1 emits infrared rays to be radiant heat to warm up a target.

Such radiant heater 1 can be used as a device for further providing warmth to an occupant of vehicle 10 after a heating mode of an air conditioner installed in vehicle 10 is activated, for example. For this purpose, radiant heater 1 is disposed in cabin 11 to face the occupant. For example, radiant heaters 1 are installed in FIG. 1 in a region around the feet of the occupant seated in a seat of vehicle 10, on an under panel under the feet of the occupant, on a roof, and on a door. Radiant heaters 1 may also be installed on a center pillar (B-pillar), a dashboard, the underside of a steering column, the underside of a center console, etc., or may be disposed to surround the feet of the occupant. Radiant heater 1 may be installed at any position in cabin 11 as long as such radiant heater 1 can warm up the occupant.

As shown in FIGS. 1 and 2, radiant heater 1 includes casing 20, cover member 30, radiant sheet 43, heat transfer sheet 44, heater element 40, and heat insulation layer 45. In radiant heater 1, radiant sheet 43, heat transfer sheet 44, heater element 40, and heat insulation layer 45 are layered in this order.

Casing 20 is disposed in cabin 11 to face the occupant. Casing 20 is a housing that houses radiant sheet 43, heater element 40, heat insulation layer 45, etc.

One face of casing 20 is open and cover member 30 is attached to the face. Cover member 30 is attached to casing 20 to cover the opening of casing 20. As will be described later, heat transfer sheet 44 and radiant sheet 43 are disposed on first surface 40a side of heater element 40, i.e., on the side facing cabin 11. Cover member 30 is disposed on first surface 40a side of heater element 40. Specifically, cover member 30 is disposed facing radiant sheet 43 to cover radiant sheet 43, heat transfer sheet 44, heater element 40, and heat insulation layer 45.

Cover member 30 is an elastic body that is of a flat plate shape and capable of elastic deformation. Cover member 30 may be an elastic body made of a heat resistant resin such as an acrylonitrile butadiene styrene (ABS) resin or a polypropylene (PP) resin.

Cover member 30 includes top plate portion 31 in the shape of a flat rectangular plate. Top plate portion 31 includes mesh portion 32 having a mesh structure in which a plurality of through holes 31a are provided. Since mesh portion 32 is formed in a central area of top plate portion 31, mesh portion 32 is disposed facing the occupant. Although FIG. 3 shows a case in which the mesh structure is of a honeycomb shape by way of example, the shape of the mesh structure is not limited thereto. For example, the mesh structure may be of a grid shape or of any other known shape. Through hole 31a may be of a known shape such as a polygonal shape or a circular shape.

The elastic modulus of cover member 30 can be adjusted by appropriately changing the opening ratio of mesh portion 32. Thus, in a region where the feet of the occupant contact, for example, the opening ratio of mesh portion 32 may be reduced because cover member 30 is considered to be elastically deformed to a large extent. In a region where the hand of the occupant contacts, the opening ratio of mesh portion 32 may be set to be greater than that of mesh portion 32 in the region where the feet of the occupant contact because cover member 30 is considered to be less elastically deformed than when the feet of the occupant contact cover member 30. As just described, the opening ratio of mesh portion 32 may be appropriately changed depending on where radiant heater 1 is placed in cabin 11.

Note that cover member 30 may be black in color. Compared to a white member, a black member is more likely to emit infrared rays when heated. As the color becomes darker, the emissivity increases. For this reason, cover member 30 may be black in color. In the present embodiment, black PP is used as cover member 30. Since a black object has the characteristic of emitting infrared rays when heated as described above, black cover member 30 can efficiently emit heat generated by heater wires 42 into cabin 11.

Heater element 40 includes base material 41 and heater wires 42.

Base material 41 is made of a flexible resin material having an electrical insulation property and capable of withstanding even heat generated by heater wires 42. The flexible resin material is a nonwoven fabric, for example. Base material 41 is of a sheet shape, and heater wires 42 are disposed on a surface of base material 41. The shape of base material 41 is formed according to the shape of radiant heater 1.

Heater wires 42 are disposed along the surface of base material 41. In the present embodiment, heater wire 42 is disposed to form a zigzag pattern on the surface of base material 41. Heater wire 42 is fixed to the surface of base material 41 by a sewing thread or an adhesive, for example.

Heater wire 42 is electrically connected to power source 15 in FIG. 1 and generates heat by receiving power supply from power source 15 in FIG. 1. Heater wire 42 includes a metal wire such as Cu, Ag, or Al, and an insulating member covering the metal wire.

Heat insulation layer 45 is provided on second surface 40b side of heater element 40, which is opposite to first surface 40a side. In other words, heat insulation layer 45 is provided on the side of a surface of base material 41 opposite to heater wires 42. Heat insulation layer 45 is a member for shielding heat transferred from heater wires 42 through base material 41. Heat insulation layer 45 is an example of a second outermost layer.

Heat insulation layer 45 is made of a heat insulating material having a heat insulating property, such as glass wool, urethane foam, urethane sponge, melamine resin, or expanded polystyrene, for example.

In order to achieve a higher heat insulating property in heat insulation layer 45, the thickness of heat insulation layer 45 is set to be greater than the thickness of radiant sheet 43.

Heat transfer sheet 44 is provided on first surface 40a of heater element 40. Heat transfer sheet 44 is disposed between heater element 40 and radiant sheet 43. In other words, heat transfer sheet 44, together with heat insulation layer 45, sandwiches heater element 40. Heat transfer sheet 44 is made of a metallic material containing copper as a main component.

Since first surface 40a of heater element 40 is of an uneven shape formed by heater wires 42 disposed on base material 41, heat transfer sheet 44 is disposed along first surface 40a with such an uneven shape.

As described above, since heat transfer sheet 44 is disposed along first surface 40a with such an uneven shape, radiant sheet 43 is disposed on first surface 40a side of heater element 40 along the uneven shape formed by base material 41 and heater wires 42. Radiant sheet 43 is disposed to sandwich, together with heater element 40, heat transfer sheet 44. Thus, heat transfer sheet 44 can convert linear heat generated by heater wires 42 into planar heat. Therefore, heat transfer sheet 44 can conduct the converted planar heat to radiant sheet 43. Radiant sheet 43 can emit, as infrared rays, the heat conducted to radiant sheet 43 (the heat from heater element 40) toward cover member 30. The infrared rays are emitted to the outside of radiant heater 1 through mesh portion 32 of cover member 30. Radiant sheet 43 is an example of a first outermost layer.

Radiant sheet 43 is made of a material such as acetate or fabric, for example.

Heater element 40, radiant sheet 43, and heat insulation layer 45 described above have flexibility. In other words, heater element 40, radiant sheet 43, and heat insulation layer 45 can be bent and stretched. This facilitates the placement of heater element 40, radiant sheet 43, and heat insulation layer 45 according to the shape of casing 20.

Although not shown in the figures, heat insulation layer 45 and second surface 40b of heater element 40 are bonded together by an adhesive layer, first surface 40a of heater element 40 and heat transfer sheet 44 are bonded together by an adhesive layer, and heat transfer sheet 44 and radiant sheet 43 are bonded together by an adhesive layer. Such an adhesive layer includes an adhesive, or a double-sided tape, for example. The adhesive layer is not shown in the figures to avoid the complication of the figures.

Thermal properties of the elements included in radiant heater 1 according to the present embodiment will be described next.

Heat insulation layer 45 is disposed to shield the heat transferred from heater wires 42 through base material 41. In order to produce the effect of shielding the heat, the thermal resistance of heat insulation layer 45 is set to be greater than that of radiant sheet 43 and greater than that of heater element 40. Here, the thermal resistance of heat insulation layer 45 is about 0.35 (m²K/W). The thermal resistance of radiant sheet 43 is about 0.001 (m²K/W), for example. Note that the thermal resistance of heat insulation layer 45 and the thermal resistance of radiant sheet 43 are given by way of example only and are not limited to those in the present disclosure.

In order to warm up the target, radiant sheet 43 may emit the heat from heater element 40 as infrared rays. For this purpose, the emissivity of radiant sheet 43 is set to be greater than that of heat insulation layer 45. Similarly, the thermal resistance of heater element 40 is set to be greater than that of radiant sheet 43. Specifically, the thermal resistance of base material 41 in heater element 40 is set to be greater than that of radiant sheet 43.

The amount of radiation from radiant sheet 43 can be increased by increasing the surface area of radiant sheet 43 as much as possible, for example. For this purpose, the surface roughness of radiant sheet 43 is set to be greater than that of heat insulation layer 45. Note that the method of increasing the amount of radiation from radiant sheet 43 is not limited to increasing the surface area. The amount of radiation from radiant sheet 43 can be increased by setting high various parameters such as the emissivity and temperature of radiant sheet 43. Since cover member 30 is irradiated with infrared rays emitted from radiant sheet 43, the emissivity of cover member 30 may be set high. For example, the emissivity of cover member 30 is set to be greater than or equal to 0.6.

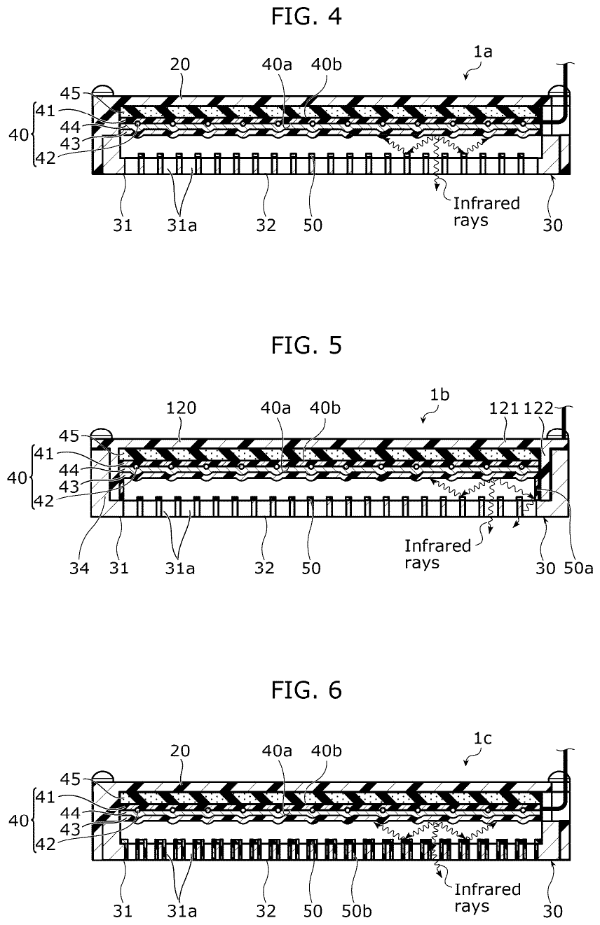

With reference to FIGS. 4 to 10, radiant heaters 1a, 1b, 1c, 1d, 1e, 1f, and 1g according to the present embodiment will be described next.

FIG. 4 is a cross-sectional view illustrating an internal structure of radiant heater 1a in which reflective member 50 is formed on cover member 30.

For example, as shown in FIG. 4, cover member 30 may include reflective member 50 disposed on a surface of cover member 30 facing heater element 40 to reflect infrared rays. Specifically, reflective member 50 that reflects infrared rays may be formed on a surface of mesh portion 32 facing heater element 40.

Reflective member 50 may be made of a material capable of reflecting infrared rays, such as aluminum. For example, reflective member 50 may be provided on mesh portion 32 by attaching aluminum tape to mesh portion 32 or by applying aluminum to mesh portion 32.

FIG. 5 is a cross-sectional view illustrating an internal structure of another radiant heater 1b in which reflective member 50a is formed on casing 20.

As shown in FIG. 5, cover member 30 may include: top plate portion 31 facing radiant sheet 43; and side plate portion 34 formed to protrude from top plate portion 31 toward heater element 40 side, for example. Casing 120 may include: bottom portion 121 on which heat insulation layer 45 is disposed and which faces heat insulation layer 45; and side wall portion 122 formed to protrude from bottom portion 121 toward heater element 40 side. In this case, side wall portion 122 may be disposed on the inner side of side plate portion 34, i.e., on the side facing heater element 40. Reflective member 50a that reflects infrared rays may be formed on a surface of side wall portion 122 facing heater element 40.

FIG. 6 is a cross-sectional view illustrating an internal structure of yet another radiant heater 1c in which reflective members 50 and 50b are formed on cover member 30.

As shown in FIG. 6, reflective member 50b that reflects infrared rays may be formed, in cover member 30, on inner surfaces of through holes 31a that constitute the mesh structure, for example.

Although reflective member 50 is formed on a surface of mesh portion 32 facing heater element 40 in FIG. 6, reflective member 50 may not be formed on mesh portion 32. As in FIG. 5, side wall portion 122 may be disposed on the inner side of side plate portion 34, and reflective member 50a that reflects infrared rays may be formed on a surface of side wall portion 122 facing heater element 40.

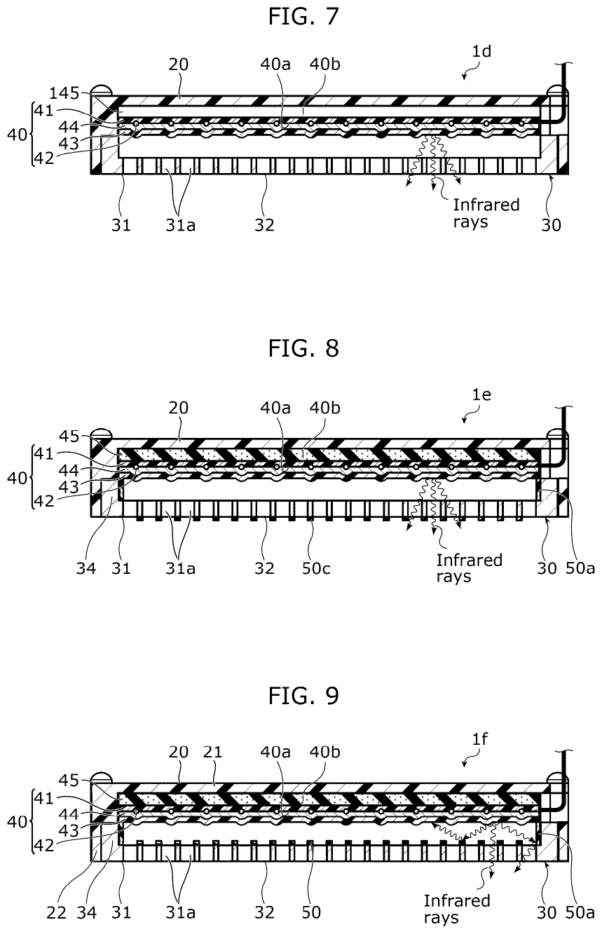

FIG. 7 is a cross-sectional view illustrating an internal structure of radiant heater 1d in which heat insulation layer 145 is an air layer.

As shown in FIG. 7, heat insulation layer 145 may be an air layer, for example. In this case, casing 20 may include a support portion capable of supporting radiant heater 1d while allowing space for heat insulation layer 145. The support portion may include a plurality of bar-shaped members that are provided parallel to one another along second surface 40b of heater element 40, for example.

As in FIG. 6, reflective member 50 may be formed on a surface of mesh portion 32 facing heater element 40, and reflective member 50b may be formed on inner surfaces of through holes 31a. As in FIG. 5, side wall portion 122 may be disposed on the inner side of side plate portion 34, and reflective member 50a that reflects infrared rays may be formed on a surface of side wall portion 122 facing heater element 40.

FIG. 8 is a cross-sectional view illustrating an internal structure of radiant heater 1e in which radiant member 50c is formed on cover member 30.

As shown in FIG. 8, cover member 30 may be made of a metal that easily reflects infrared rays, such as aluminum, for example. Radiant member 50c that emits infrared rays may be formed on a surface of cover member 30 opposite to heater element 40. In other words, radiant member 50c may be formed on a surface of mesh portion 32 opposite to heater element 40. Radiant member 50c may be made of a black material. Radiant member 50c may be provided on mesh portion 32 by attaching black tape to mesh portion 32 or by applying black paint to mesh portion 32. Even when cover member 30 is heated by infrared rays emitted from heater element 40, radiant member 50c of cover member 30 can emit infrared rays to the outside of radiant heater 1e.

As shown in FIG. 8, reflective member 50a that reflects infrared rays may be formed on a surface of side plate portion 34 facing heater element 40.

FIG. 9 is a cross-sectional view illustrating an internal structure of yet another radiant heater 1f in which reflective member 50a is formed on cover member 30.

As shown in FIG. 9, cover member 30 may include: top plate portion 31 facing radiant sheet 43; and side plate portion 34 formed to protrude from top plate portion 31 toward heater element 40 side, for example. Casing 20 may include: bottom portion 21 on which heat insulation layer 45 is disposed and which faces heat insulation layer 45; and side wall portion 22 formed to protrude from bottom portion 21 toward heater element 40 side. In this case, side plate portion 34 may be disposed on the inner side of side wall portion 22, i.e., on the side facing heater element 40. Reflective member 50a that reflects infrared rays may be formed on a surface of side plate portion 34 facing heater element 40.

Although FIG. 9 shows the case in which reflective member 50 is formed on a surface of mesh portion 32 facing heater element 40 by way of example, reflective member 50 may not be formed on mesh portion 32.

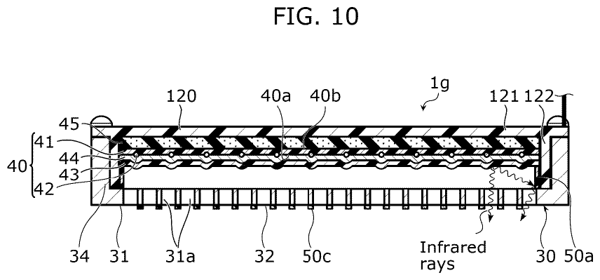

FIG. 10 is a cross-sectional view illustrating an internal structure of yet another radiant heater 1g in which reflective member 50a is formed on casing 120.

As in FIG. 9, cover member 30 in FIG. 10 may include top plate portion 31 and side plate portion 34. Casing 120 may include bottom portion 121 and side wall portion 122. In this case, side wall portion 122 may be disposed on the inner side of side plate portion 34, i.e., on the side facing heater element 40. Side wall portion 122 may include reflective member 50a disposed on a surface of side wall portion 122 facing heater element 40 to reflect infrared rays. Radiant member 50c that emits infrared rays may be formed on a surface of cover member 30 opposite to heater element 40.

### Measurement Results

Measurement results of radiant heaters according to the present embodiment will be described next.

Surface temperatures of radiant sheets of (1) a radiant heater without a cover member, (2) a radiant heater with a cover member in which no reflective member is provided, and (3) a radiant heater with a cover member in which a reflective member is provided were measured.

In the case of (1), since infrared rays were emitted to the outside, the surface temperature of the radiant sheet was lower than those in (2) and (3).

In the case of (2), since the cover member is provided, the surface temperature of the radiant sheet was higher than that in (1).

In the case of (3), the surface temperature of the radiant sheet was higher than those in (1) and (2). This is thought to be because some of infrared rays emitted from the radiant sheet were emitted to the outside of the radiant heater, but the remaining infrared rays were reflected by the reflective member and returned to the radiant sheet, thereby warming up the radiant sheet.

Thus, in the case of (3), it can be expected that the returned infrared rays warm up the radiant sheet and the radiant sheet emits infrared rays with a higher energy than those in (1) and (2), i.e., an increased amount of radiation can be expected.

### Operation and Effect

The operation and effect of radiant heaters 1, 1a, 1b, 1c, 1d, 1e, 1f, and 1g according to the present embodiment will be described next.

According to the Stefan-Boltzmann's law, however, even if emissivity increases, an amount of radiation from a material of a radiant surface is more likely to be small unless the temperature of the material of the radiant surface is high. Regarding the thermal radiation heater described in PTL 1, there is no disclosure for a structure to raise the temperature of the material of the radiant surface, and no measures are taken to further increase the amount of radiation from the material of the radiant surface.

In view of the above, a first aspect of the present disclosure provides radiant heater 1, 1a, 1b, 1c, 1d, 1e, 1f, or 1g to be installed in cabin 11 of vehicle 10. Radiant heater 1, 1a, 1b, 1c, 1d, 1e, 1f, or 1g includes: heater element 40 in a flat plate shape; a first outermost layer (radiant sheet 43) provided on first surface 40a side of heater element 40, i.e., on the side facing cabin 11; and a second outermost layer (heat insulation layer 45) provided on second surface 40b side of heater element 40, second surface 40b side being opposite to first surface 40a side. The thermal resistance of the second outermost layer (heat insulation layer 45) is greater than that of the first outermost layer (radiant sheet 43).

According to this, since the thermal resistance of radiant sheet 43 is lower than that of heat insulation layer 45, the temperature of radiant sheet 43 increases more easily. Thus, the heat of heater element 40 is more easily radiated from radiant sheet 43. As a result, the heat of heater element 40 is radiated from radiant sheet 43.

According to radiant heater 1, 1a, 1b, 1c, 1d, 1e, 1f, or 1g, the amount of radiation can be therefore increased.

A second aspect of the present disclosure provides radiant heater 1, 1a, 1b, 1c, 1d, 1e, 1f, or 1g according to the first aspect of the present disclosure, in which the thermal resistance of heat insulation layer 45 is greater than that of heater element 40.

According to this, since the thermal resistance of radiant sheet 43 is lower than that of heat insulation layer 45, the temperature of radiant sheet 43 increases more easily. Thus, the heat of heater element 40 is more easily conducted to radiant sheet 43 and more easily radiated from radiant sheet 43. As a result, the amount of radiation can be increased in radiant heater 1, 1a, 1b, 1c, 1d, 1e, 1f, or 1g.

A third aspect of the present disclosure provides radiant heater 1, 1a, 1b, 1c, 1d, 1e, 1f, or 1g according to the first or second aspect of the present disclosure, in which the thermal resistance of heater element 40 is greater than that of radiant sheet 43.

According to this, the heat of heater element 40 is more easily conducted to radiant sheet 43 and more easily radiated from radiant sheet 43. As a result, the amount of radiation can be increased in radiant heater 1, 1a, 1b, 1c, 1d, 1e, 1f, or 1g.

A fourth aspect of the present disclosure provides radiant heater 1, 1a, 1b, 1c, 1d, 1e, 1f, or 1g according to any one of the first to third aspects of the present disclosure, in which the emissivity of radiant sheet 43 is greater than that of heat insulation layer 45.

According to this, since the emissivity of radiant sheet 43 is greater than that of heat insulation layer 45, the heat of heater element 40 is more easily radiated from radiant sheet 43. Thus, the heat of heater element 40 is radiated from radiant sheet 43. As a result, the amount of radiation can be increased in radiant heater 1, 1a, 1b, 1c, 1d, 1e, 1f, or 1g.

A fifth aspect of the present disclosure provides radiant heater 1, 1a, 1b, 1c, 1d, 1e, 1f, or 1g according to any one of the first to fourth aspects of the present disclosure, in which the surface roughness of radiant sheet 43 is greater than that of heat insulation layer 45.

According to this, the increased surface area can be expected to increase the amount of radiation from radiant sheet 43.

A sixth aspect of the present disclosure provides radiant heater 1, 1a, 1b, 1c, 1d, 1e, 1f, or 1g according to any one of the first to fifth aspects of the present disclosure, in which heater element 40 includes: base material 41 in a sheet shape; and heater wire 42 disposed on base material 41, and radiant sheet 43 is disposed on first surface 40a side of heater element 40 along the uneven shape formed by base material 41 and heater wire 42.

According to this, since unevenness can be formed in radiant sheet 43 according to the layout of heater wire 42, the surface area of radiant sheet 43 can be increased.

When heater wire 42 and radiant sheet 43 are viewed in cross section along a plane perpendicular to the longitudinal direction of heater wire 42, radiant sheet 43 can be disposed to surround most part of heater wire 42. Thus, the heat of heater wire 42 is more easily conducted to radiant sheet 43.

As a result, the amount of radiation can be increased in radiant heater 1, 1a, 1b, 1c, 1d, 1e, 1f, or 1g.

A seventh aspect of the present disclosure provides radiant heater 1, 1a, 1b, 1c, 1d, 1e, 1f, or 1g according to any one of the first to sixth aspects of the present disclosure, in which heater element 40, radiant sheet 43, and heat insulation layer 45 each have flexibility.

According to this, radiant heater 1, 1a, 1b, 1c, 1d, 1e, 1f, or 1g can be installed in a bent state. Thus, radiant heater 1, 1a, 1b, 1c, 1d, 1e, 1f, or 1g has a high degree of freedom for installation.

An eighth aspect of the present disclosure provides radiant heater 1, 1a, 1b, 1c, 1d, 1e, 1f, or 1g according to any one of the first to seventh aspects of the present disclosure, in which the thickness of heat insulation layer 45 is greater than that of radiant sheet 43.

According to this, the heat insulation effect of heat insulation layer 45 can be expected to be further enhanced. Moreover, since the amount of radiation in radiant sheet 43 can be expected to be further increased, the heat of heater element 40 is more easily radiated from radiant sheet 43.

A ninth aspect of the present disclosure provides radiant heater 1, 1a, 1b, 1c, 1d, 1e, 1f, or 1g according to any one of the first to eighth aspects of the present disclosure, further including heat transfer sheet 44 disposed between heater element 40 and radiant sheet 43.

According to this, since the heat of heater wire 42 is conducted to heat transfer sheet 44, the heat linearly generated by heater wire 42 can be changed into heat planarly generated by heat transfer sheet 44. Thus, the surface area capable of radiating heat can be increased.

Moreover, since the heat linearly generated by heater wire 42 is changed into the heat planarly generated by heat transfer sheet 44, the temperature of entire heat transfer sheet 44 becomes substantially uniform. In other words, linear radiation from heater wire 42 is converted to planar radiation by heat transfer sheet 44. Since the heat is conducted in a planar fashion from heat transfer sheet 44, radiant sheet 43 can emit infrared rays substantially uniformly from its surface. As a result, the amount of radiation can also be made uniform in radiant heater 1, 1a, 1b, 1c, 1d, 1e, 1f, or 1g.

A tenth aspect of the present disclosure provides radiant heater 1b according to any one of the first to ninth aspects of the present disclosure, further including casing 120 that houses heater element 40, the first outermost layer (radiant sheet 43), and the second outermost layer (heat insulation layer 45). Casing 120 includes: bottom portion 121 that faces the second outermost layer (heat insulation layer 45); and side wall portion 122 provided to protrude from bottom portion 121 toward heater element 40 side. Reflective member 50a that reflects infrared rays is provided on a surface of side wall portion 122.

According to this, since reflective member 50a can reflect infrared rays emitted from the surface of radiant sheet 43 toward the mesh structure, the loss of infrared rays due to cover member 30 can be reduced. As a result, the amount of radiation in radiant sheet 43 can be expected to be further increased.

An eleventh aspect of the present disclosure provides radiant heater 1b according to the tenth aspect of the present disclosure, further including cover member 30 disposed to cover first surface 40a side of heater element 40. Reflective member 50 that reflects infrared rays is provided on a surface of cover member 30 facing heater element 40.

According to this, since reflective member 50 can reflect infrared rays emitted from the surface of radiant sheet 43, the loss of infrared rays due to cover member 30 can be reduced. As a result, the amount of radiation in radiant sheet 43 can be expected to be further increased.

Moreover, since heater element 40 is disposed to cover first surface 40a side in radiant heater 1b, contact with the body of a person can be prevented from occurring even if the body of the person unexpectedly comes closer.

A twelfth aspect of the present disclosure provides radiant heater 1e or 1f according to any one of the first to ninth aspects of the present disclosure, further including cover member 30 disposed to cover first surface 40a side of heater element 40. Cover member 30 includes: top plate portion 31 that faces the first outermost layer (radiant sheet 43); and side plate portion 34 provided to protrude from top plate portion 31 toward heater element 40 side. Reflective member 50a that reflects infrared rays is provided on a surface of side plate portion 34.

According to this, since reflective member 50a can reflect infrared rays emitted from the surface of radiant sheet 43 toward the mesh structure, the loss of infrared rays due to cover member 30 can be reduced. As a result, the amount of radiation in radiant sheet 43 can be expected to be further increased.

A thirteenth aspect of the present disclosure provides radiant heater 1f according to the twelfth aspect of the present disclosure, in which reflective member 50 that reflects infrared rays is provided on a surface of cover member 30 facing heater element 40.

According to this, since reflective member 50 can reflect infrared rays emitted from the surface of radiant sheet 43, the loss of infrared rays due to cover member 30 can be reduced. As a result, the amount of radiation in radiant sheet 43 can be expected to be further increased.

Moreover, since cover member 30 is disposed to cover first surface 40a side of heater element 40, contact with the body of a person can be prevented from occurring even if the body of the person unexpectedly comes closer.

A fourteenth aspect of the present disclosure provides radiant heater 1a, 1b, 1c, or 1f according to any one of the first to ninth aspects of the present disclosure, further including cover member 30 disposed to cover first surface 40a side of heater element 40. Reflective member 50 that reflects infrared rays is provided on a surface of cover member 30 facing heater element 40.

According to this, since reflective member 50 can reflect infrared rays emitted from the surface of radiant sheet 43, the loss of infrared rays due to cover member 30 can be reduced. As a result, the amount of radiation in radiant sheet 43 can be expected to be further increased.

Moreover, since cover member 30 is disposed to cover first surface 40a side of heater element 40, contact with the body of a person can be prevented from occurring even if the body of the person unexpectedly comes closer.

A fifteenth aspect of the present disclosure provides radiant heater 1a, 1b, 1c, or 1f according to any one of the eleventh, thirteenth, and fourteenth aspects of the present disclosure, in which cover member 30 includes mesh portion 32 having a mesh structure. Reflective member 50 that reflects infrared rays is provided on a surface of mesh portion 32 facing heater element 40.

According to this, since reflective member 50 can reflect infrared rays emitted from the surface of radiant sheet 43 back into radiant sheet 43, the loss of infrared rays due to cover member 30 can be reduced. As a result, the amount of radiation in radiant sheet 43 can be expected to be further increased.

A sixteenth aspect of the present disclosure provides radiant heater 1c according to the fifteenth aspect of the present disclosure, in which reflective member 50b that reflects infrared rays is provided on an inner surface of through hole 31a that constitutes the mesh structure.

According to this, since reflective member 50b can reflect infrared rays emitted from the surface of radiant sheet 43 to be passed through through hole 31a, the loss of infrared rays due to cover member 30 can be reduced. As a result, the amount of radiation in radiant sheet 43 can be expected to be further increased.

A seventeenth aspect of the present disclosure provides radiant heater 1e or 1g according to any one of the first to ninth aspects of the present disclosure, further including cover member 30 that reflects infrared rays, cover member 30 being disposed to cover first surface 40a side of heater element 40. Radiant member 50c that emits infrared rays is provided on a surface of cover member 30 opposite to heater element 40.

According to this, even when cover member 30 is heated by heater element 40, radiant member 50c can emit infrared rays. Thus, the amount of radiation in radiant sheet 43 can be expected to be further increased.

Particularly when cover member 30 is made of a metal that easily reflects infrared rays, such as aluminum, entire cover member 30 is more easily heated by heater element 40 as compared to when a cover member is made of a resin material and then a radiant member is formed on the cover member. Thus, the amount of radiation can be increased.

An eighteenth aspect of the present disclosure provides radiant heater 1e or 1g according to the seventeenth aspect of the present disclosure, in which cover member 30 includes mesh portion 32 having a mesh structure.

According to this, since the mesh structure allows infrared rays emitted from the surface of radiant sheet 43 to pass through the mesh structure, the amount of radiation in radiant sheet 43 can be expected to be further increased.

A nineteenth aspect of the present disclosure provides radiant heater 1g according to the seventeenth or eighteenth aspect of the present disclosure, further including casing 120 that houses heater element 40, the first outermost layer (radiant sheet 43), and the second outermost layer (heat insulation layer 45). Casing 120 includes: bottom portion 121 that faces the second outermost layer (heat insulation layer 45); and side wall portion 122 provided to protrude from bottom portion 121 toward heater element 40 side. Reflective member 50a that reflects infrared rays is provided on a surface of side wall portion 122.

According to this, since reflective member 50a can reflect infrared rays emitted from the surface of radiant sheet 43 toward the mesh structure, the loss of infrared rays due to cover member 30 can be reduced. As a result, the amount of radiation in radiant sheet 43 can be expected to be further increased.

A twentieth aspect of the present disclosure provides radiant heater 1e according to the seventeenth or eighteenth aspect of the present disclosure, in which cover member 30 includes: top plate portion 31 that faces the first outermost layer (radiant sheet 43); and side plate portion 34 provided to protrude from top plate portion 31 toward heater element 40 side. Reflective member 50a that reflects infrared rays is provided on a surface of side plate portion 34.

According to this, since reflective member 50a can reflect infrared rays emitted from the surface of radiant sheet 43 toward the mesh structure, the loss of infrared rays due to cover member 30 can be reduced. As a result, the amount of radiation in radiant sheet 43 can be expected to be further increased.

A twenty-first aspect of the present disclosure provides radiant heater 1a, 1b, 1c, 1e, 1f, or 1g according to any one of the eleventh to eighteenth aspects of the present disclosure, in which the emissivity of cover member 30 is greater than or equal to 0.6.

According to this, even when cover member 30 absorbs infrared rays emitted from the surface of radiant sheet 43, cover member 30 can emit the absorbed heat as infrared rays. As a result, the amount of radiation can be expected to be further increased in radiant heater 1a, 1b, 1c, 1e, 1f, or 1g.

### Other Variations

Although the radiant heaters according to the present disclosure have been described above with reference to the above embodiment, the present disclosure is not limited to such an embodiment. Forms obtained by making various modifications to the above embodiment that can be conceived by those skilled in the art may also be included in the scope of the present disclosure without materially departing from the spirit of the present disclosure.

For example, when the heat insulation layer in the radiant heater according to the present disclosure is made of a heat insulating material, no casing may be included in the components of the radiant heater. When the heat insulation layer is an air layer, on the other hand, the casing may be included in the components of the radiant heater.

Note that forms obtained by making various modifications to the above embodiment that can be conceived by those skilled in the art, as well as forms obtained by combining structural components and functions in the embodiment are included in the scope of the present disclosure without materially departing from the spirit of the present disclosure.

While the embodiment has been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2024-013329 filed on Jan. 31, 2024.

### INDUSTRIAL APPLICABILITY

The present disclosure is applicable to a radiant heater device configured to emit radiant heat, and more particularly to a radiant heater device to be installed in a cabin of a vehicle.

1. A radiant heater to be installed in a cabin of a vehicle, the radiant heater comprising:
a heater element in a flat plate shape;
a first outermost layer provided on a first surface side of the heater element, the first surface side being a side facing the cabin; and
a second outermost layer provided on a second surface side of the heater element, the second surface side being opposite to the first surface side,
wherein a thermal resistance of the second outermost layer is greater than a thermal resistance of the first outermost layer.

2. The radiant heater according to claim 1,
wherein the thermal resistance of the second outermost layer is greater than a thermal resistance of the heater element.

3. The radiant heater according to claim 1,
wherein a thermal resistance of the heater element is greater than the thermal resistance of the first outermost layer.

4. The radiant heater according to claim 1,
wherein an emissivity of the first outermost layer is greater than an emissivity of the second outermost layer.

5. The radiant heater according to claim 1,
wherein a surface roughness of the first outermost layer is greater than a surface roughness of the second outermost layer.

6. The radiant heater according to claim 1,
wherein the heater element includes a base material in a sheet shape, and a heater wire disposed on the base material, and
the first outermost layer is disposed on the first surface side of the heater element along an uneven shape formed by the base material and the heater wire.

7. The radiant heater according to claim 1,
wherein the heater element, the first outermost layer, and the second outermost layer each have flexibility.

8. The radiant heater according to claim 1,
wherein a thickness of the second outermost layer is greater than a thickness of the first outermost layer.

9. The radiant heater according to claim 1, further comprising:
a heat transfer sheet disposed between the heater element and the first outermost layer.

10. The radiant heater according to claim 1, further comprising:
a casing that houses the heater element, the first outermost layer, and the second outermost layer,
wherein the casing includes a bottom portion that faces the second outermost layer, and a side wall portion provided to protrude from the bottom portion toward a heater element side, and
a reflective member that reflects an infrared ray is provided on a surface of the side wall portion.

11. The radiant heater according to claim 10, further comprising:
a cover member disposed to cover the first surface side of the heater element,
wherein a reflective member that reflects an infrared ray is provided on a surface of the cover member facing the heater element.

12. The radiant heater according to claim 1, further comprising:
a cover member disposed to cover the first surface side of the heater element,
wherein the cover member includes a top plate portion that faces the first outermost layer, and a side plate portion provided to protrude from the top plate portion toward a heater element side, and
a reflective member that reflects an infrared ray is provided on a surface of the side plate portion.

13. The radiant heater according to claim 12,
wherein a reflective member that reflects an infrared ray is provided on a surface of the cover member facing the heater element.

14. The radiant heater according to claim 1, further comprising:
a cover member disposed to cover the first surface side of the heater element,
wherein a reflective member that reflects an infrared ray is provided on a surface of the cover member facing the heater element.

15. The radiant heater according to claim 11,
wherein the cover member includes a mesh portion having a mesh structure, and
a reflective member that reflects an infrared ray is provided on a surface of the mesh portion facing the heater element.

16. The radiant heater according to claim 15,
wherein the reflective member is further provided on an inner surface of a through hole that constitutes the mesh structure.

17. The radiant heater according to claim 1, further comprising:
a cover member that reflects an infrared ray, the cover member being disposed to cover the first surface side of the heater element,
wherein a radiant member that emits an infrared ray is provided on a surface of the cover member being opposite to the heater element.

18. The radiant heater according to claim 17,
wherein the cover member includes a mesh portion having a mesh structure.

19. The radiant heater according to claim 17, further comprising:
a casing that houses the heater element, the first outermost layer, and the second outermost layer,
wherein the casing includes a bottom portion that faces the second outermost layer, and a side wall portion provided to protrude from the bottom portion toward a heater element side, and
a reflective member that reflects an infrared ray is provided on a surface of the side wall portion.

20. The radiant heater according to claim 11,
wherein an emissivity of the cover member is greater than or equal to 0.6.
